(19) United States
(12) Patent Application Publication
(10) Pub. No.: US 2013/0319952 A1
(43) Pub. Date: Dec. 5, 2013

(54) DEOILING HYDROCYCLONE

(71) Applicant: Mark E. Wolf, Katy, TX (US)

(72) Inventor: Mark E. Wolf, Katy, TX (US)

(73) Assignee: NATIONAL OILWELL VARCO, L.P., Houston, TX (US)

(21) Appl. No.: 13/486,970

(22) Filed: Jun. 1, 2012

(51) Int. Cl. B04C 11/00; B04C 7/00; B01D 21/26; C02F 1/38; C02F 101/32

(52) U.S. Cl. 210/741; 210/787; 210/739; 210/512.1; 210/512.2

(57) ABSTRACT

A method of controlling a hydrocyclone system for separating a fluid mixture wherein the system includes a separator vessel for receiving the fluid mixture and performing a primary separation of the more dense and the less dense fluid phase thereby forming an interface within the separator, and a hydrocyclone apparatus having a first and second hydrocyclone compartments to separate the phases. The method includes alternating the flow rate through the hydrocyclone apparatus, alternating the interface or fluid mixture level in the separator vessel between a first level and a second level; and alternating the second hydrocyclone compartment between an open state in flow communication with the first hydrocyclone compartment and a closed state in isolation from the first compartment.

### FIELD OF THE INVENTION

The present invention generally relates to hydrocyclones for separating a mixture of two fluid components. In particular, but not exclusively, the present invention relates to deoiling hydrocyclones.

### BACKGROUND TO THE INVENTION

Produced water in the oil industry is water coproduced with oil and gas from hydrocarbons reservoirs. As international regulations for disposal of hydrocarbons at sea are enforced, there has been an increased focus on methods and technologies for produced water treatment.

Cyclone separators have been known for many years, having wide applications in the oil industry. Cyclone separators which can separate a mixture of immiscible fluids, such as oil and water mixtures, are generally known as hydrocyclones. At present, hydrocyclone technology is the preferred solution for produced water treatment.

“Deoiling hydrocyclones” are commonly used to separate oil from produced water after a primary separation process has been effected so that water can be disposed of in a non-contaminated state. Examples of deoiling hydrocyclones may be found in U.S. Pat. No. 5,017,288, U.S. Pat. No. 5,071,557 and U.S. Pat. No. 5,667,686, all of which are hereby incorporated by reference in their entirety.

The operation of a deoiling hydrocyclone can be described as follows. A fluid (for example a mixture of water and oil) from a primary separation process enters the hydrocyclone body through a tangential inlet restriction in the cyclonic body. This causes the fluid within the cyclonic body to spin, thereby creating centrifugal forces thousands of times higher than the force of gravity within the fluid. The centrifugal forces multiply the natural buoyancy of small oil droplets with low density within the water phase which has a higher density. The centrifugal forces direct the heavier water towards the edges of the cyclone, thus retaining the lighter oil in the center of the cyclone. The two phases of oil and water can then be extracted from the cyclone separately. The water is extracted via a clean water outlet while the oil is extracted via a waste water reject outlet.

For many applications, a single hydrocyclone does not have sufficient capacity. Therefore a number of hydrocyclones will be installed within a single hydrocyclone vessel such that they operate in parallel with a single set of common piping connections. The number of hydrocyclones installed within the hydrocyclone vessel can be changed to adjust the flow capacity of the hydrocyclone vessel.

The flow rate through a hydrocyclone is directly proportional to the square root of the differential pressure applied across the hydrocyclone from the inlet to the waste water reject outlet. As the differential pressure across the hydrocyclone increases, the velocity of the spinning fluid also increases, which in turn causes the buoyancy force acting on the oil droplets to increase. Therefore, higher differential pressure results in improved oil removal performance.

Nevertheless, deoiling hydrocyclones experience efficiency problems. For example, complications arise when trying to control the overall flow or flowrate of the fluid through a hydrocyclone system. This is achieved using control valves which are adjusted to change the flow of liquid from processes upstream and/or to processes downstream of the hydrocyclone. Operational control is essential for proper hydrocyclone performance, as indicated in “Operational Control of Hydrocyclones During Variable Produced Water Flow Rates—FrØy Case Study” published in SPE Production and Operations in August 2007, herein incorporated by reference in its entirety.

FIG. 1 shows the oil removed from a deoiling hydrocyclone as a function of flow rate for a typical set of operating conditions. In the graph of FIG. 1, the flow rate is represented in barrels per day (BPD) on the horizontal axis, and the outlet oil concentration in parts per million is shown on the vertical axis. It can be seen from this graph that there is a reduction in oil removal performance as the flowrate drops.

FIG. 2 shows the flowrates and corresponding oil removal performance of a typical system that controls flow through a hydrocyclone system. The control system aims to maintain a constant level in an upstream separation vessel or tank when the water flow rate into the upstream vessel or tank varies over time.

Variation in flowrate through the hydrocyclone results in a variation in differential pressure and a corresponding variation in oil removal performance. This causes decreased separation efficiency of hydrocyclone systems.

There is an ongoing desire to improve hydrocyclone systems for use in offshore oil operations and elsewhere. In particular, there is a desire to increase the efficiency of hydrocyclone systems.

### SUMMARY OF THE INVENTION

According to a first aspect of the present invention there is provided a method of controlling a hydrocyclone system for separating a fluid mixture having a less dense fluid component and a more dense liquid component, wherein the hydrocyclone system comprises a separator vessel for receiving the fluid mixture and performing a primary separation of the fluid mixture which forms an interface level between the more dense liquid component and the less dense fluid component and a hydrocyclone apparatus, the hydrocyclone apparatus being arranged to generate circular flows thereby generating centrifugal forces to separate the less dense fluid component from the more dense liquid component, the hydrocyclone apparatus comprising first and second hydrocyclone compartments, wherein the first hydrocyclone compartment has an inlet for inletting the fluid mixture from the separator vessel into the first hydrocyclone compartment, a first outlet for discharge of the less dense fluid component and a second outlet for discharge of the more dense liquid component, the method comprising the steps of: alternating the flow rate through the hydrocyclone apparatus between a first flow rate and a second flow rate to thereby alternate the interface or fluid mixture level in the separator vessel between a first level and a second level which is lower than the first level; and

alternating the second hydrocyclone compartment between an open state wherein the second hydrocyclone compartment is in flow communication with the first hydrocyclone compartment and a closed state wherein the second hydrocyclone compartment is isolated from the first hydrocyclone compartment to thereby isolate a portion of the circular flows within the second hydrocyclone compartment, such that when the interface or fluid mixture in the separator vessel reaches the first level, the second hydrocyclone compartment is placed in the open state, and when the interface or fluid mixture in the separator vessel reaches the second level, the second hydrocyclone compartment is placed in the closed state.

According to a second aspect of the present invention there is also provided a control system for a hydrocyclone system for separating a fluid mixture having a less dense fluid component and a more dense liquid component, wherein the hydrocyclone system comprises a separator vessel for receiving the fluid mixture and performing a primary separation of the fluid mixture which forms an interface level between the more dense liquid component and the less dense fluid component, and a hydrocyclone apparatus, the hydrocyclone apparatus being arranged to generate circular flows thereby generating centrifugal forces to separate the less dense fluid component from the more dense liquid component, the hydrocyclone apparatus comprising first and second hydrocyclone compartments, wherein the first hydrocyclone compartment has an inlet for inletting the fluid mixture from the separator vessel into the first hydrocyclone compartment, a first outlet for discharge of the less dense fluid component and a second outlet for discharge of the more dense liquid component, the control system comprising:

a flow rate controller for alternating the flow rate through the hydrocyclone apparatus between a first flow rate and a second flow rate to thereby alternate the interface or fluid mixture level between the more dense liquid component and the less dense fluid component in the separator vessel between a first level and a second level which is lower than the first level; and a valve for alternating the second hydrocyclone compartment between an open state wherein the second hydrocyclone compartment is in flow communication with the first hydrocyclone compartment and a closed state wherein the second hydrocyclone compartment is isolated from the first hydrocyclone compartment to thereby isolate a portion of the cyclones within the second hydrocyclone compartment, such that when the interface or fluid mixture in the separator vessel reaches the first level, the second hydrocyclone compartment is placed in the open state, and when the interface or fluid mixture in the separator vessel reaches the second level, the second hydrocyclone compartment is placed in the closed state.

According to the present invention, therefore, the flowrate through the hydrocyclone is intentionally alternated between two fixed flow rate set points, and the interface or fluid mixture level in the upstream process is allowed to vary between a high operating level and a low operating level. In addition, a second hydrocyclone vessel or a second chamber within a multi-chambered hydrocyclone vessel is cycled in and out of service, for example with the use of automated valves or the like, so that a larger number of cyclones is in service at the high flow rate, and a smaller number of cyclones is in service at the low flow rate. Advantageously, this method enables the hydrocyclone to always operate at its optimum efficiency point resulting in improved overall oil removal performance.

The hydrocyclone apparatus may include, for example, multi-chambered or multi-compartment hydrocyclone vessels of the type described in U.S. patent application Ser. No. 12/671,590, which is hereby incorporated by reference in its entirety or multiple hydrocyclone vessel systems.

### BRIEF DESCRIPTION OF THE DRAWINGS

FIG. 1 is a graph which represents the oil removed from a prior art deoiling hydrocyclone as a function of flowrate;

FIG. 2 is a graph which shows the flowrates and corresponding oil removal performance of a typical system that controls flow through hydrocyclones;

FIG. 3 shows a cross-sectional elevation view of an embodiment of a multi-compartment hydrocyclone vessel that may be controlled in accordance with the present invention;

FIG. 4 is a graph which shows three possible oil removal performance curves as a function of flowrate for the multi-compartment hydrocyclone vessel shown in FIG. 3;

FIG. 5 is a graph which shows the flow rate into the upstream vessel (Flow In), the flow rate through the hydrocyclone (Flow Out), tank level in the upstream vessel, and oil removal performance of the multi-compartment hydrocyclone vessel shown in FIG. 3 when controlled in accordance with the present invention;

FIG. 6 shows an embodiment of a control system in accordance with the present invention based on the current industry accepted control method with differential pressure ratio control; and

FIG. 7 shows another embodiment of a control system in accordance with the present invention based on an alternate control method described in U.S. patent application Ser. No. 13/280,507 which is herein incorporated by reference in its entirety.

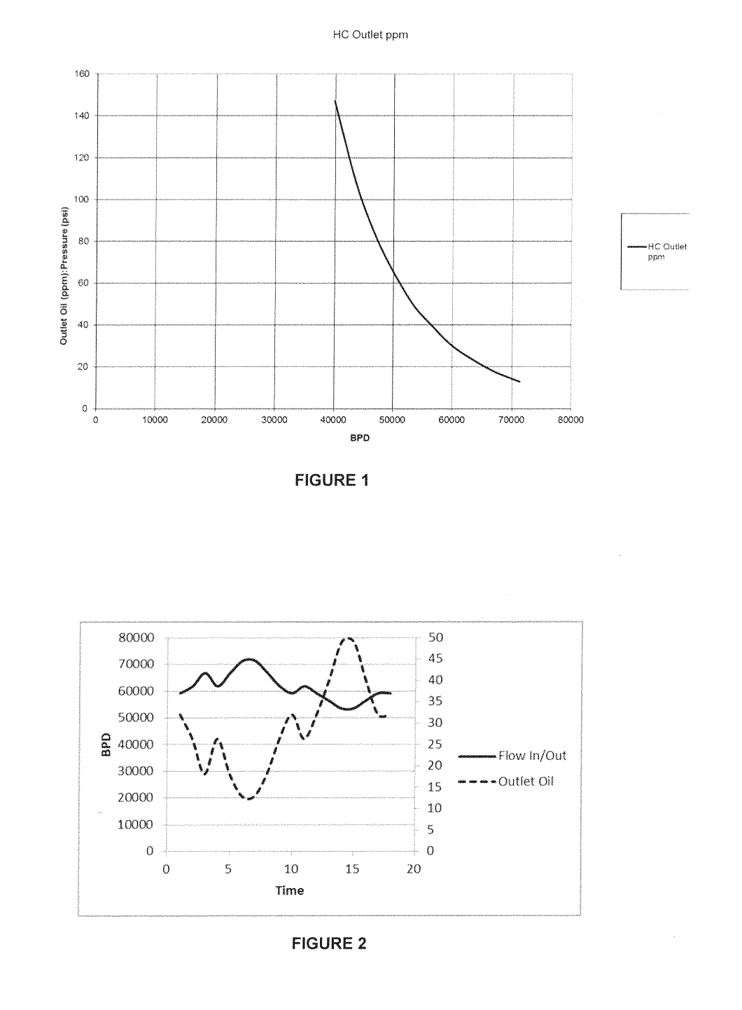

### DETAILED DESCRIPTION

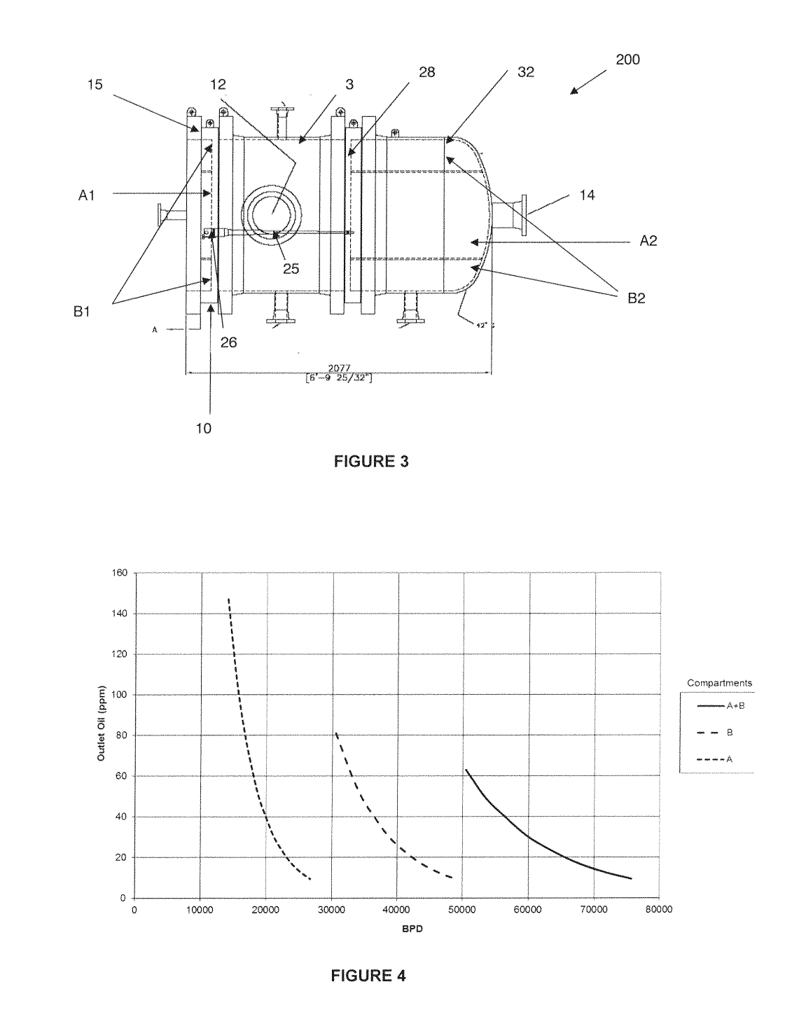

An embodiment of a hydrocyclone vessel that may be controlled in accordance with the present invention is described below with reference to FIG. 3. FIG. 3 shows a multicompartment hydrocyclone vessel 200 as is described in U.S. patent application Ser. No. 12/671,590 which is hereby incorporated by reference in its entirety. The vessel 200 comprises an inlet chamber or first pressure vessel 3, a second pressure vessel 32 having a closed end, an end plate 15, an overflow plate 10 and an underflow plate 28, between which a plurality of cyclone liners 25 can be located.

The end plate 15 is seated against the overflow plate 10, holding the overflow plate 10 in place and creating overflow chambers or compartments A1, B1, in which overflow outlets 26 of the cyclone liners are located. The downstream pressure vessel 32 is seated against the underflow plate 28, holding the underflow plate in place and creating underflow compartments A2, B2.

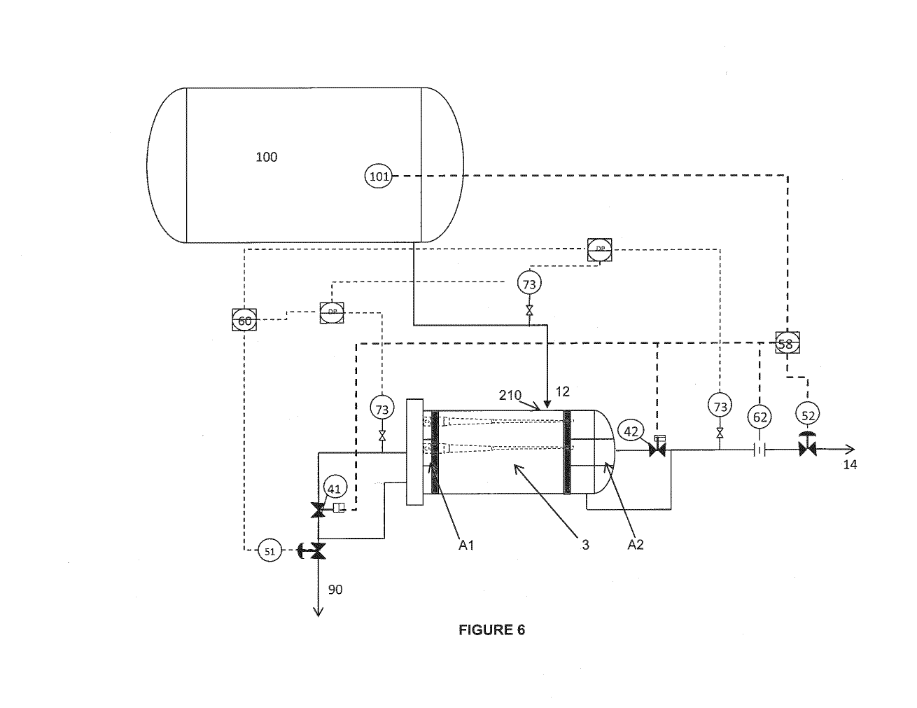

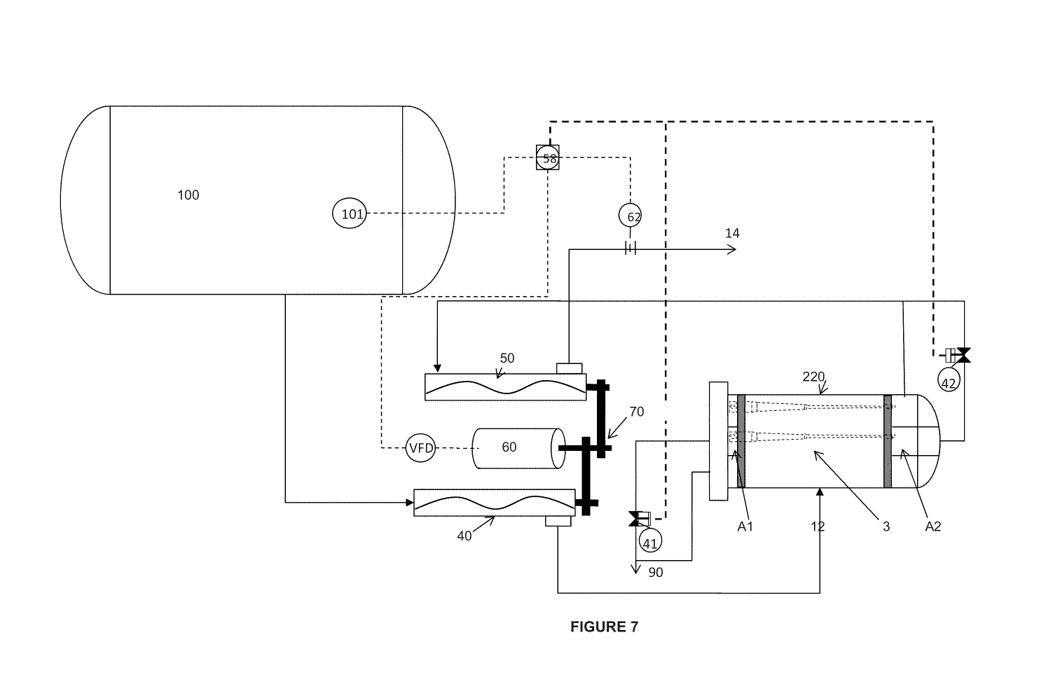

In use, an immiscible mixture of two fluids such as oil and water from an upstream pressure vessel such as a separator vessel or tank (not shown, corresponding to separator vessel 100 as shown in FIGS. 6 and 7) enters the first pressure vessel 3 via an inlet nozzle 12 under pressure. The fluid mixture then enters cyclone liners 25 through an inlet (not shown) located in an inlet chamber created inside the first pressure vessel 3 between the overflow plate 10 and the underflow plate 28.

As the fluid flow is forced down the cyclone liner 25, it takes up a helical form along the cyclone liner's inner wall. The fluid flow is accelerated in the conically reducing section, to the high velocities required to create the strong centrifugal forces. As a result, the water and oil are separated and can be extracted from the water outlet 14 and a waster water reject outlet also referred to as an oily reject line (not shown) respectively.

In the preferred embodiment, the hydrocyclone vessel 200 shown in FIG. 3 is configured such that, in use, a portion of the cyclones are isolated in an inner compartment A (in the overflow chamber A1 or underflow chamber A2) and another portion are isolated in an outer compartment B (in the overflow chamber B1 or underflow chamber B2). By using for example valves or the like (not shown, corresponding to isolation valves 41 and 42, respectively of FIGS. 6 and 7) on the outlets of the overflow and underflow chambers for compartments A and B, it is possible to operate the cyclones for just inner compartment A, just outer compartment B, or both compartments A and B by placing them in an open/closed state accordingly. Alternatively, instead of a single multi-chambered hydrocyclone vessel, a similar performance can be achieved with two separate hydrocyclone vessels. The compartments can have either the same or different number of hydrocyclone liners.

Three possible oil removal performance versus flowrate curves, for compartments A, B, and A+B, respectively, are shown in FIG. 4. By automating the valves for inner compartment A, it is possible to cycle or alternate the inner compartment A between an open state and a closed state (in and out of service) to coincide with cycling between a high and low flowrate set point or level.

The high flow rate set point can coincide with the optimum oil removal efficiency flow rate for compartment A+B as shown in FIG. 4, and the low flowrate set point can coincide with the optimum oil removal efficiency flow rate for outer compartment B as shown in FIG. 4. This cycling between two flowrates through the deoiling hydrocyclone causes the fluid interface level in the upstream pressure vessel or tank to fluctuate between a high and a low level. When the level is at the high set point, inner compartment A may be switched on for example by opening valves on its overflow and underflow outlets, and the flowrate through the hydrocyclone is controlled at the high flow rate set point.

The fluid flowrate exiting the upstream pressure vessel is now higher than the fluid flowrate entering the upstream pressure vessel, which causes the level in the upstream pressure vessel to drop. When the fluid interface or fluid mixture level reaches the low set point, inner compartment A is switched off by closing the valves on its overflow and underflow exits, and the flowrate through the hydrocyclone is controlled at the low flow rate set point. At this point, the fluid flowrate entering the upstream pressure vessel is higher than the fluid flowrate exiting the upstream pressure vessel causing the level in the upstream pressure vessel to rise. This process of cycling or alternating the additional capacity (i.e. inner compartment A) of the hydrocyclone vessel 200 in and out of service continues and allows the hydrocyclone vessel to operate at its best efficiency point for any flow rate entering the upstream pressure vessel that is between the high and low flow rate set levels.

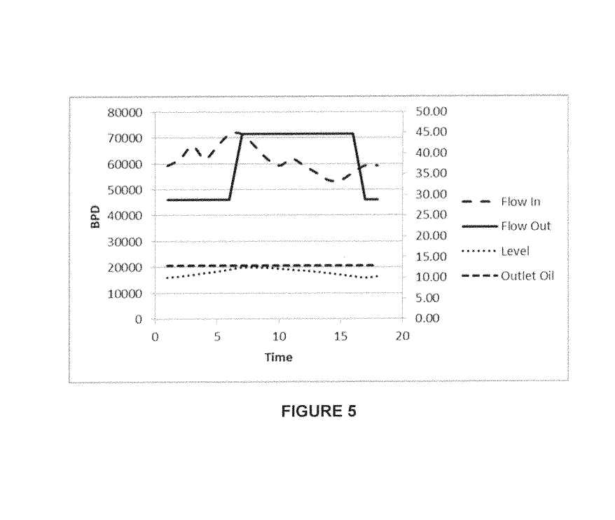

FIG. 5 shows the flowrates entering the upstream separation vessel (Flow In), and through a hydrocyclone vessel 200 (Flow Out), upstream vessel interface or fluid mixture level and oil removal performance of a system that is controlled using a dual rate flow control method in accordance with the present invention. It can be seen from FIG. 5 that the oil removal performance remains constant while the interface or fluid mixture level in the upstream vessel is allowed to fluctuate.

A control system in accordance with the present invention will now be described with reference to FIG. 6. FIG. 6 shows a dual rate flow control system required for use with a traditional level controlled hydrocyclone with differential pressure ratio control on the oily reject line 90.

The control system comprises an upstream separator vessel or separator 100 and a hydrocyclone vessel 210. In the preferred embodiment, the hydrocyclone vessel 210 shown in FIG. 6 may take the form of the hydrocyclone vessel 200 illustrated in FIG. 3.

An underflow control valve 52 controls the flow through the hydrocyclone based on the input from a flow transmitter 62 on the hydrocyclone underflow. The flow rate set-point for this flow control system and the position of overflow and underflow isolation valves 41, 42 on the inner compartment A are adjusted based on the input from a Level Control Transmitter in the upstream separation vessel 101. An overflow control valve 51 controls the oily water reject flow rate based on the input from the three pressure transmitters 73 on the inlet 12, overflow, and underflow lines, respectively.

The fluid interface or fluid mixture level in the separator 100 is allowed to vary between a high operating level and a low operating level. In addition, as described above with reference to the hydrocyclone vessel 200 of FIG. 3, the hydrocyclone vessel 210 may be controlled using valves 41 and 42, so that a larger number of cyclones is in service at the high flow rate, and a smaller number of cyclones is in service at the low flow rate.

Advantageously, such a system (i.e. comprising a hydrocyclone vessel 210 and an upstream separator 100, for example) may be adapted to operate at any given flowrate between the high and low flow rate set points of the system, whilst operating the hydrocyclone vessel 210 at maximum efficiency. The upstream separator 100 serves as a volumetric accumulator which allows the hydrocyclone vessel 210 to operate at two specific flowrates, one high, one low.

A further control system in accordance with the present invention will now be described with reference to FIG. 7. FIG. 7 shows a dual rate flow control system incorporated with a pressure recovery control method, as described in U.S. patent application Ser. No. 13/280,507.

The system shown in FIG. 7 comprises an upstream separator vessel or separator 100 and a hydrocyclone vessel 220. In the preferred embodiment, the hydrocyclone vessel 220 shown in FIG. 7 may take the form of the hydrocyclone vessel 200 illustrated in FIG. 3.

A pump 40 is provided coupled to the inlet 12 of the hydrocyclone vessel 220. Moreover, an energy harvester 50 is provided coupled to the water outlet 14 of the hydrocyclone vessel 220. The energy harvester 50 turns pressure energy in the water outlet 14 into mechanical energy. An energy transfer mechanism 70 is provided to apply this energy to the pump 40. A drive mechanism 60 is further provided. The drive mechanism is coupled to the energy transfer mechanism 70, or to other parts of the system as appropriate. For instance, the drive mechanism may be coupled to the pump 40 or the energy harvester 50.

The energy transfer mechanism can be considered a torque transfer device, arranged to transfer torque from the rotating shaft of the energy harvester 50 to the rotating shaft of the pump 40. The energy transfer mechanism 70 is arranged to ensure a fixed ratio between the speeds of rotation of the rotating shafts of the pump 40 and the energy harvester 50. Accordingly, a fixed volumetric ratio of fluid passes through the pump 40 and the energy harvester 50. As a result, the ratio of fluid through the inlet 12 and the water outlet 14 is fixed, which in turn fixes the relative proportion of fluid which passes through the oily reject line 90.

The drive mechanism 60 may comprise an electronic motor and electronic speed control (for example, a variable frequency drive). The electronic motor is coupled to the energy transfer mechanism 70 and can thus control the rate of fluid flow through the pump 40, the energy harvester 50 and hydrocyclone vessel 200.

Using the drive mechanism 60, the flowrate through the hydrocyclone vessel 220 is allowed to vary between a high operating level and a low operating level. Using the drive mechanism 60 to control the flowrate avoids the need to control the flow rate using an outlet valve or the like. In addition, as described above with reference to the hydrocyclone vessel 200 of FIG. 3, the hydrocyclone vessel 220 may be controlled using valves 41 and 42, so that a larger number of cyclones is in service at the high flow rate, and a smaller number of cyclones is in service at the low flow rate.

It should be noted that the term “comprising” does not exclude other elements or steps, the term “a” or “an” does not exclude a plurality, a single feature may fulfill the functions of several features recited in the claims and reference signs in the claims shall not be construed as limiting the scope of the claims. It should also be noted that the Figures are not necessarily to scale; emphasis instead generally being placed upon illustrating the principles of the present invention.

What is claimed is:

1. A method of controlling a hydrocyclone system for separating a fluid mixture having a less dense fluid component and a more dense liquid component, wherein the hydrocyclone system comprises a separator vessel for receiving the fluid mixture and performing a primary separation of the more dense liquid and the less dense fluid thereby forming an interface, and a hydrocyclone apparatus, the hydrocyclone apparatus being arranged to generate circular flows thereby generating centrifugal forces to separate the less dense fluid component from the more dense liquid component, the hydrocyclone apparatus comprising first and second hydrocyclone compartments, wherein the first hydrocyclone compartment has an inlet for inletting the fluid mixture from the separator vessel into the first hydrocyclone compartment, a first outlet for discharge of the less dense fluid component and a second outlet for discharge of the more dense liquid component, the method comprising the steps of:
alternating the flow rate through the hydrocyclone apparatus between a first flow rate and a second flow rate to thereby alternate the interface or fluid mixture level in the separator vessel between a first level and a second level which is lower than the first level; and
alternating the second hydrocyclone compartment between an open state wherein the second hydrocyclone compartment is in flow communication with the first hydrocyclone compartment and a closed state wherein the second hydrocyclone compartment is isolated from the first hydrocyclone compartment to thereby isolate a portion of the circular flows within the second hydrocyclone compartment, such that when the interface or fluid mixture in the separator vessel reaches the first level, the second hydrocyclone compartment is placed in the open state, and when the interface or fluid mixture in the separator vessel reaches the second level, the second hydrocyclone compartment is placed in the closed state.

2. The method of controlling a hydrocyclone system of claim 1, wherein the less dense fluid component is oil and the more dense liquid component is water.

3. The method of controlling a hydrocyclone system of claim 1 or claim 2, wherein the hydrocyclone apparatus is a multi-chambered hydrocyclone vessel.

4. The method of controlling a hydrocyclone system of claim 1 or claim 2, wherein the hydrocyclone apparatus comprises at least two hydrocyclone vessels.

5. The method of controlling a hydrocyclone system of claim 1, wherein an underflow isolation valve alternates the second hydrocyclone compartment between the open and closed states.

6. The method of controlling a hydrocyclone system of claim 1, wherein an overflow isolation valve alternates the second hydrocyclone compartment between the open and closed states.

7. The method of controlling a hydrocyclone system of claim 1, wherein the hydrocyclone apparatus comprises a third hydrocyclone compartment and wherein said step of alternating the second hydrocyclone compartment further comprises simultaneously alternating the third hydrocyclone compartment between an open state wherein the third hydrocyclone compartment is in flow communication with the first and second hydrocyclone compartments and a closed state wherein the third hydrocyclone compartment is in flow communication only with the second hydrocyclone compartment to thereby isolate a portion of the circular flows within the second and hydrocyclone compartments, such that when the interface or fluid mixture in the separator vessel reaches the first level, the third hydrocyclone compartment is placed in the open state, and when the interface or fluid mixture in the separator vessel reaches the second level, the third hydrocyclone compartment is placed in the closed state.

8. The method of controlling a hydrocyclone system of claim 1, wherein the flowrate through the hydrocyclone apparatus is alternated using an underflow control valve arranged to receive input from a flow transmitter on a hydrocyclone underflow.

9. The method of controlling a hydrocyclone system of claim 1, wherein the flowrate through the hydrocyclone apparatus is alternated using an overflow control valve arranged to receive input from at least one pressure transmitter.

10. The method of controlling a hydrocyclone system of claim 1, wherein the flow split between the second outlet and the first outlet of the hydrocyclone apparatus is controlled using differential pressure ratio control.

11. The method of controlling a hydrocyclone system of claim 1, wherein the flow split between the second outlet and the first outlet of the hydrocyclone apparatus is controlled using pressure recovery control.

12. A control system for a hydrocyclone system for separating a fluid mixture having a less dense fluid component and a more dense liquid component, wherein the hydrocyclone system comprises a separator vessel for receiving the fluid mixture and performing a primary separation of the more dense liquid and less dense fluid thereby forming an interface within the separator and a hydrocyclone apparatus, the hydrocyclone apparatus being arranged to generate circular flows thereby generating centrifugal forces to separate the less dense fluid component from the more dense liquid component, the hydrocyclone apparatus comprising first and second hydrocyclone compartments, wherein the first hydrocyclone compartment has an inlet for inletting the fluid mixture from the separator vessel into the first hydrocyclone compartment, a first outlet for discharge of the less dense fluid component and a second outlet for discharge of the more dense liquid component, the control system comprising:
a flow rate controller for alternating the flow rate through the separator vessel between a first flow rate and a second flow rate to thereby alternate the interface or fluid mixture level in the separator vessel between a first level and a second level which is lower than the first level; and
a valve for alternating the second hydrocyclone compartment between an open state wherein the second hydrocyclone compartment is in flow communication with the first hydrocyclone compartment and a closed state wherein the second hydrocyclone compartment is isolated from the first hydrocyclone compartment to thereby isolate a portion of the cyclones within the second hydrocyclone compartment, such that when the interface or fluid mixture in the separator vessel reaches the first level, the second hydrocyclone compartment is placed in the open state, and when the interface or fluid mixture in the separator vessel reaches the second level, the second hydrocyclone compartment is placed in the closed state.

13. The control system for a hydrocyclone system of claim 12, wherein the less dense fluid component is oil and the more dense liquid component is water.

14. The control system for a hydrocyclone system of claim 12 or claim 13, wherein the hydrocyclone apparatus is a multi-chambered hydrocyclone vessel.

15. The control system for a hydrocyclone system of claim 12 or claim 13, wherein the hydrocyclone apparatus comprises at least two hydrocyclone vessels.

16. The control system for a thydrocyclone system of claim 12, wherein the valve for alternating the second hydrocyclone compartment comprises at least one underflow isolation valve.

17. The control system for a hydrocyclone system of claim 12, wherein the valve for alternating the second hydrocyclone compartment comprises at least one overflow isolation valve.

18. The control system for a hydrocyclone system of claim 12, further comprising a differential pressure ratio controller arranged to control the flow split between the second outlet and the first outlet of the hydrocyclone apparatus.

19. The control system for a hydrocyclone system of claim 12, further comprising a pressure recovery controller arranged to control the flow split between the second outlet and the first outlet of the hydrocyclone apparatus.

20. The control system for a hydrocyclone system of claim 12, further comprising an energy harvester.
